(19) United States
(12) Patent Application Publication
(10) Pub. No.: US 2014/0334996 A1
(43) Pub. Date: Nov. 13, 2014

(54) VENTURI REACTOR AND METHOD FOR PRODUCING USABLE BY PRODUCTS USING VENTURI REACTOR

(71) Applicant: LP Amina LLC, Charlotte, NC (US)

(72) Inventors: Matthew Targett, Sarasota, FL (US); William Latta, Mooresville, NC (US)

(73) Assignee: LP Amina LLC, Charlotte, NC (US)

(21) Appl. No.: 14/274,467

(22) Filed: May 9, 2014

Related U.S. Application Data
(60) Provisional application No. 61/821,992, filed on May 10, 2013.

(51) Int. Cl. C01B 31/32

(52) U.S. Cl. CPC C01B 31/32
USPC 423/168

(57) ABSTRACT

A process for producing a usable product in a reactor comprising introducing co-reactants comprising a fuel source and oxygen into a first section through an inlet, the fuel source comprising carbon; combusting at least a portion of the fuel source and oxygen in an exothermic reaction in the first section using a burner; transferring the co-reactants through a second section that includes a throat having a size that is smaller than a size of the first section, such that a vacuum is induced and a velocity of the co-reactants increases; transferring the co-reactants into a third section that is downstream from the throat and includes an inner wall having a size that is greater than the size of the throat; depositing at least a portion of the uncombusted carbon and a metal oxide along the inner wall, wherein the metal oxide is introduced into at least one of the sections; converting the deposited metal oxide into the usable product in a carbothermic reduction reaction within a molten slag along the inner wall at a temperature of at least 1600° C.

### CROSS-REFERENCE TO RELATED PATENT APPLICATIONS

This application claims the benefit of and priority to U.S. Provisional Patent App. No. 61/821,992, which was filed on May 10, 2013. The foregoing U.S. provisional application is incorporated by reference herein in its entirety.

### BACKGROUND

This application relates generally to the production of heat and usable chemicals, materials, or by-products using venturi-type reactors that are otherwise configured to produce carbon black. More specifically, this application relates to an improved reactor (e.g., a venturi reactor) for use in the generation of heat as well as for producing usable by-products that may be used in a variety of applications, such as in the production of calcium carbide (CaC₂) or other chemicals.

CaC₂ is a basic chemical that has utility in the production of other useful compounds such as acetylene (C₂H₂), which is commonly used in industrial organic chemistry for producing other compounds such as vinyl chloride or polyvinyl chloride. For example, CaC₂ may react with water to form acetylene according to the following formula:

CaC₂+2(H₂O)→C₂H₂+Ca(OH)₂

There are a number of different ways to produce CaC₂. For example, CaC₂ may be produced by heating a mixture of lime (e.g., calcium oxide or CaO) and carbon. CaC₂ may also be generated in an electric-arc furnace from the reaction of coke and calcium oxide when heated to a temperature ranging from 1500-2100° C. with carbon monoxide as another by-product, as expressed by the following reaction:

CaO+3C→CaC₂+CO

CaC₂ may also be produced by the direct reaction of coke with calcium oxide and oxygen, with carbon monoxide being produced as a by-product. This reaction is illustrated chemically by the following formula:

$$( 3 + n ) C + CaO + \frac{n}{2} {O}_{2} -> {CaC}_{2} + ( n + 1 ) CO$$

It may be desirable to investigate new methods for the production of CaC₂, especially in locations where oil reserves are limited and coal resources are plentiful. Methods of producing CaC₂, such as using electric arc furnaces, have poor energy efficiency and may also produce potentially detrimental environmental effects. It would be advantageous, for example, to produce CaC₂ or other carbon-based chemicals using a more efficient and more environmentally friendly method that relies on existing coal reserves. Especially advantageous would be a process where less expensive relative low-quality coal (i.e. coal with a low specific heat value) or a waste biomass with a low specific heat value could be employed as a reactant.

### SUMMARY

One embodiment of this application relates to a process for producing a usable product in a reactor. The process comprises introducing co-reactants comprising a fuel source and oxygen into a first section of the reactor through at least one inlet, wherein the fuel source comprises carbon. The process further comprises combusting at least a portion of the fuel source and oxygen in an exothermic reaction in the first section, wherein a burner is provided to generate a flame to combust the fuel source and oxygen. The process further comprises transferring the co-reactants through a second section of the reactor, the second section including a throat having a size that is smaller than a size of the first section, such that a vacuum is induced and a velocity of the co-reactants increases through the reactor. The process further comprises transferring the co-reactants into a third section of the reactor that is downstream from the throat, the third section including an inner wall having a size that is greater than the size of the throat. The process further comprises depositing at least a portion of the uncombusted carbon and a metal oxide along the inner wall of the third section, wherein the metal oxide is introduced into at least one of the first, second, and third sections of the reactor. The process further comprises converting the deposited metal oxide into the usable product in a carbothermic reduction reaction within a molten slag along the inner wall, wherein the carbothermic reaction occurs at a temperature of at least 1600° C. The process may further comprise recovering the molten slag containing the usable product from the reactor.

The size of the throat may be configured to decrease when moving from a first end of the throat that is adjacent to the first section to a second end of the throat that is adjacent to the third section of the reactor. The size of the throat may be configured to decrease at a constant rate and continuous manner from the first end to the second end of the throat.

The at least one inlet may include first and second inlets, wherein each of the first and second inlets is tangentially aligned relative to the first section in a direction that is transverse and offset from a longitudinal axis of the reactor to swirl the co-reactants introduced into the first section. At least one of an additive, a carbide, a residual oil, and a calcium source may be introduced into the third section of the reactor through a third inlet, to promote the formation of the molten slag along the inner wall.

A compound comprising at least one of an additive, a carbide, a residual oil, and a calcium source may be introduced into the second section of the reactor through a secondary inlet.

The molten slag may be recovered from the reactor through a first outlet. The reactor may optionally include a second outlet through which off gases are removed from the reactor.

The conversion of the metal oxide to the usable product may occur by reacting the deposited metal oxide with carbon, where the carbon is from at least one of the fuel source, combustion off gas, and another co-reactant introduced into the first section.

The usable product may include a carbide that comprises at least one element from at least one of groups one and two of the periodic table.

Another embodiment relates to a process for producing a usable product in a reactor. The process comprises introducing co-reactants into a first chamber defined by a cylindrical first section having an inner diameter, where the co-reactants comprise at least a fuel source and oxygen, the fuel source comprising carbon. The process further comprises combusting at least a portion of the fuel source and oxygen in the first chamber using a burner in an exothermic reaction; and transferring the co-reactants from the first chamber to a second chamber fluidly connected therewith. The second chamber is defined by a second section that extends between first and second ends, and a size of the first end is smaller than the inner diameter of the first section. The process further comprises transferring the co-reactants from the second chamber to a third chamber fluidly connected therewith, where the third chamber is defined by a cylindrical third section having an inner diameter that is larger than a size of the second end. The process further comprises forming a molten slag in the third chamber by carbothermic reduction of uncombusted carbon and a metal oxide, where the metal oxide is introduced into at least one of the first, second, and third chambers. The molten slag contains at least a portion of the usable product. The difference between the size of the first end and the inner diameter of the first section and between the size of the second end and the inner diameter of the third section influences a velocity and a temperature to promote the carbothermic reduction of the uncombusted carbon and the metal oxide.

The size of the first end may be the same as the size of the second end, such that the second section has a constant size throughout. The second section may be cylindrically shaped having a constant inner diameter that is smaller than the inner diameters of both of the first and third sections.

The size of the first end may be larger than the size of the second end, such that the size of the second section progressively narrows moving from the first end to the second end. The second section may be frusto-conical shaped.

The first end may be connected to the first section through a first side wall, and the second end may be connected to the third section through a second side wall.

The usable product may comprise at least one element from at least one of group eleven of the periodic table, group twelve of the periodic table, and lanthanoids. The conversion of the at least one element to the usable product may occur by reacting the deposited elements with carbon, where the carbon is from at least one of the fuel source, combustion off gas, and another co-reactant introduced into the first section.

Yet another embodiment relates to a process for producing a usable product in a venturi reactor. The process comprises introducing co-reactants into a first chamber, where the co-reactants comprise carbon and oxygen. The process further comprises combusting at least a portion of the co-reactants in the first chamber, and transferring the co-reactants from the first chamber to a second chamber, where the second chamber is configured as a continuously uninterrupted tapered body to increase a velocity of the co-reactants. The process further comprises transferring the co-reactants from the second chamber to a third chamber, wherein uncombusted carbon and a compound react in a molten slag to form usable product. The compound is introduced into at least one of the first and third chambers of the reactor, and the compound comprises at least one of an oxide, a hydroxide, and a carbonate.

The compound and uncombusted carbon may react within the molten slag in a carbothermic reduction reaction at a temperature of at least 1600° C. The molten slag may form along an inner wall of the reactor. The compound may be introduced into the first chamber. A second compound comprising at least one of an additive, a carbide, a residual oil, and a calcium source may optionally be introduced into the third chamber of the reactor in order to further promote the carbothermic reaction in the third chamber.

The carbon may be a hybrid fuel source comprising carbon from a biomass and carbon from a non-biomass carbon source.

The second chamber may be configured as a linear tapered body that is continuous and uninterrupted along the entire body.

### BRIEF DESCRIPTION OF THE DRAWINGS

FIG. 1 is a side cross-sectional view of an exemplary embodiment of a reactor.

FIG. 1A is a cross-sectional view of the reactor shown in FIG. 1, taken along the line 1A-1A.

FIG. 2 is a side cross-sectional view of another exemplary embodiment of a reactor.

FIG. 2A is a cross-sectional view of the reactor shown in FIG. 2, taken along the line 2A-2A.

FIG. 3 is a side cross-sectional view of another exemplary embodiment of a reactor.

FIG. 4 is a side cross-sectional view of another exemplary embodiment of a reactor.

FIG. 5 is a side cross-sectional view of yet another exemplary embodiment of a reactor.

### DETAILED DESCRIPTION

Referring generally to the Figures, disclosed herein are reactors (e.g., venturi-type carbon black reactors) and processes for producing products (e.g., chemicals, materials, etc.). For example, the reactors and processes, as disclosed herein, may produce carbon-based chemicals including, but not limited to, calcium carbide (CaC₂), lithium carbide (Li₂C₂), sodium carbide (Na₂C₂), potassium carbide (K₂C₂), magnesium carbide (Mg₂C₃ or MgC₂). The reactors and processes, as disclosed herein, may include a casing defining a chamber that includes a feature (e.g., a throat, a venturi, etc.) that is configured to induce a vacuum in the chamber to influence the turbulence and the temperature to promote carbothermic reduction of reactants introduced into the chamber. Thus, the reactors and processes, as disclosed herein, may be configured to produce heat and usable products.

Venturi reactors are used in carbon black production plants, where typically natural gas is combusted in air, oxygen enriched air, or pure oxygen for the purposes of generating high temperature combustion gases in which excess fuel or additional carbonaceous “make” (e.g., an aromatic oil) is injected and thermally decomposed into fine particles of carbon black and hydrogen off-gas. Such venturi reactors, however, are not operated in a slagging mode with the injection of metal oxides to achieve carbothermic reduction of, for example, calcium oxide (CaO) to CaC₂ that takes place at temperatures above 1500° C. in a liquid molten slag media. Preferably, the carbothermic reduction reaction occurs at a temperature of at least 1600° C. in the molten slag.

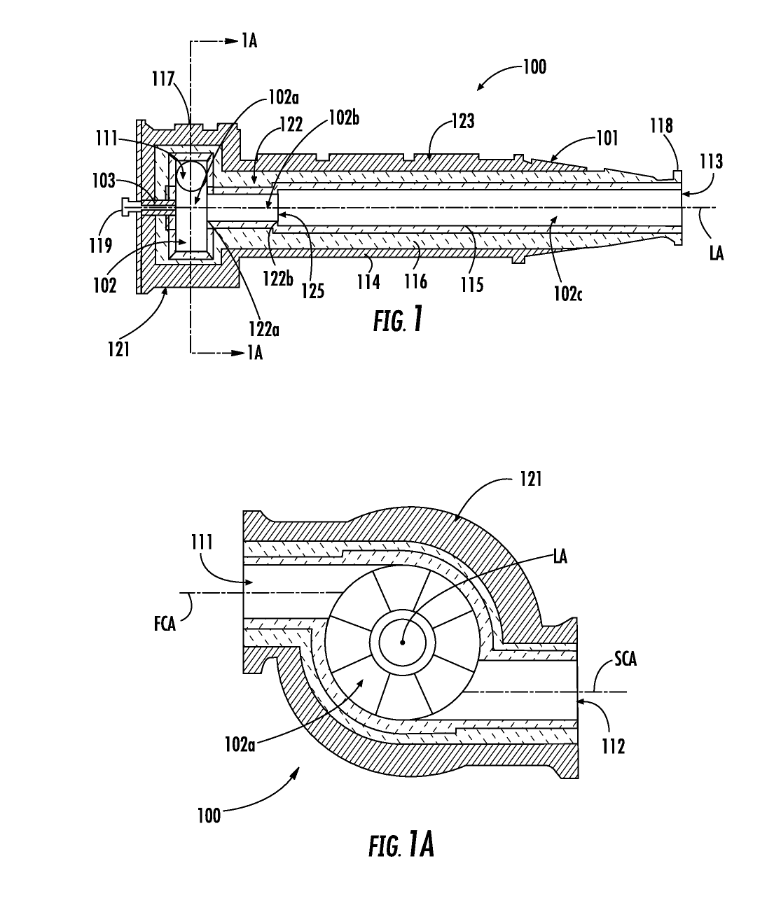

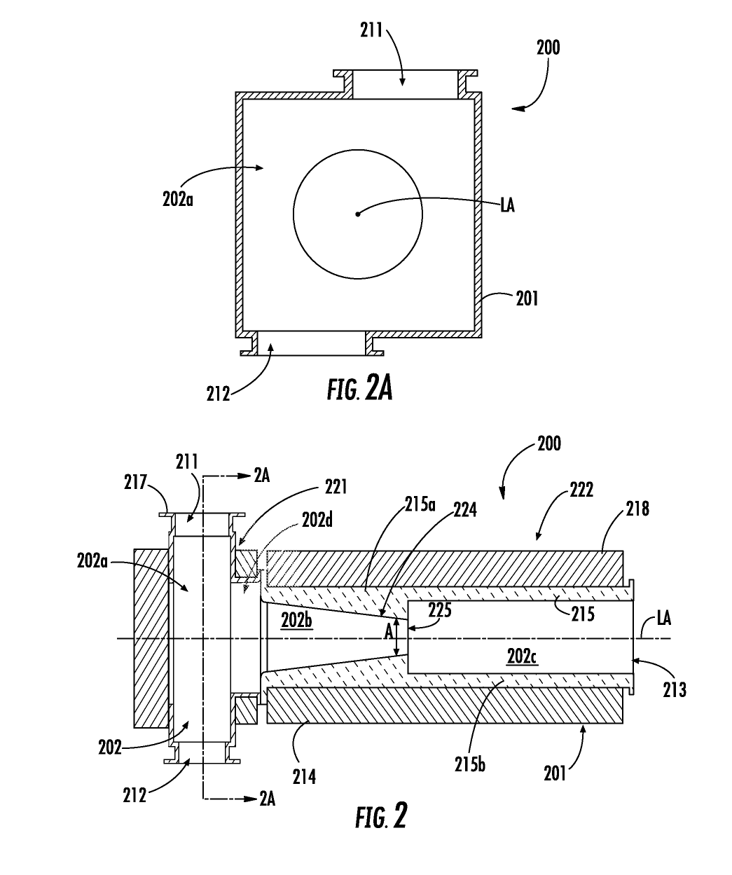

FIGS. 1 and 1A illustrate an exemplary embodiment of a reactor 100, and FIGS. 2 and 2A illustrate another exemplary embodiment of a reactor 200. Each reactor may include a casing (e.g., a housing) defining one or more than one chamber within the casing. Each reactor may include one or more than one inlet configured to introduce one or more than one reactant (e.g. co-reactants) into, for example, a portion of the casing (e.g., a chamber thereof). Each reactor may include one or more than one outlet configured to allow the recovery of a usable product and/or off gases from the reactor (e.g., the casing). Each inlet and/or outlet may be integrally formed with the casing, or may be formed separately and coupled to the casing. Each reactor may include a burner configured to combust one or more reactants within the casing.

As shown in FIGS. 1 and 1A, the reactor 100 includes a casing 101 defining a chamber 102 therein, a burner 103 configured to combust reactant(s) introduced into the reactor, a first inlet 111 configured to introduce a first reactant, such as a fuel source (e.g., coal, natural gas, etc.), into the chamber, a second inlet 112 configured to introduce a second reactant (e.g., oxygen) into the chamber 102, and an outlet 113. It is noted that the reactor 100 and the other reactors, as disclosed herein, may be configured to receive other materials as reactants. As non-limiting examples, calcium oxide (CaO), calcium carbonate (CaCO₃), coke, lime, or any combination thereof may be used as reactants, as well as any other suitable material. As additional non-limiting examples, an oxide, a hydroxide, a carbonate (e.g., of calcium, lithium, sodium, potassium, magnesium, etc.), or any other suitable element or compound may be used as a reactant/co-reactant. More non-limiting examples of reactants/co-reactants include methane, a compound made from biomass or any renewable source, municipal solid waste, and/or any carbonaceous material. Thus, the biomass can be an engineered biomass, such as tires, or a waste biomass. Furthermore, a usable product, such as CaC₂, may be used as reactant/co-reactant.

The casing 101 of the reactor 100 may include one or more than one wall that defines the one or more than one chamber 102 (e.g., a combustion chamber) inside the casing 101. As shown in FIG. 1, the casing 101 includes an outer wall 114 (e.g., an outer layer) and inner wall 115 (e.g., an inner layer) that extend from a first end 117 to a second end 118 of the casing 101. Each wall 114, 115 may include one or more sections (e.g., portions, etc.), where each section may be substantially cylindrical (e.g., barrel) shaped, tapered (e.g., frusto-conical), or may have any suitable shape. Each section of each wall 114, 115 may be centered on or offset from a central longitudinal axis LA, such that the combustion chamber 102 is defined by the inner wall 115. For example, the combustion chamber 102 may be configured to extend along the central longitudinal axis LA. The casing may be elongated having a length that is greater than the diameter. In other words, the reactor may have a relatively large aspect ratio, where the ratio of the length to the width or height, which may be the same, such as if the reactor has a circular cross-section.

The casing 101 may include one or more sections that are configured to define the one or more chambers inside the reactor 100. Each section of the casing 101 may be generally defined by a portion of the outer wall 114 and/or the inner wall 115. As shown in FIG. 1, the casing 101 includes a first section 121, a second section 122, and a third section 123, where the second section 122 is disposed between the first and third sections 121, 123. Each section of the casing 101 may correspond to and define a respective section of the chamber 102 (e.g., a sub-chamber) or define a separate chamber altogether. For example, the first section 121 of the casing may define the first section 102a of the chamber (e.g., the combustion zone), the second section 122 of the casing 101 may define the second section 102b of the chamber, and the third section 123 of the casing 101 may define the third section 102c of the chamber.

As shown in FIG. 1, the first section 121 of the casing 101 is configured having a first diameter and a first length, the second section 122 of the casing 101 is configured having a second diameter and a second length, and the third section 123 of the casing 101 is configured having a third diameter and a third length. For example, the size (e.g., first diameter, first length) of the inside of the first section 121 of the casing 101 may define the size (e.g., diameter, length) of the combustion zone. Also, for example, the size (e.g., second diameter, second length) of the inside of the second section 122 of the casing 101 may define the size of the throat. Additionally, the size (e.g., third diameter, third length) of the inside of the third section 123 of the casing 101 may define the size of the third section 102c of the chamber 102, which may be the chamber that is downstream of the throat and where the carbothermic reactions occur along the inside of the inner layer of the casing 101. The different sections of the casing 101 may be configured having similar or different outside (e.g., external) sizes and/or shapes along with similar or different inside sizes and/or shapes. For example, the outside of the casing 101 may be generally uniform, while the inside of the casing 101 defines a chamber having different shapes (e.g., diameters) in the different sections.

As shown in FIG. 1, the first diameter is greater than both the second and third diameters, and the third diameter is greater than the second diameter. The difference between the size of the first section 121 and the size of the second section 122, and the difference between the size of the second section 122 and the size of the third section 123 may be configured to influence the a velocity of the reactant(s) through the reactor and the temperature to promote the carbothermic reduction of the reactant(s). For example, the difference between the size of a first end 122a (e.g., an inlet end) of the second section 122 and the size of the inner diameter of the first section 121 may influence the velocity and temperature of the co-reactants. Also, for example, the difference between the size of the second end 122b (e.g., an outlet end) of the second section and the size of the inner diameter of the third section 123 may influence the velocity and temperature of the co-reactants. Also shown, the first length is shorter than both the second and third lengths, and the third length is greater than the second length. Thus, the combustion zone may have a relatively larger diameter, but is relatively short in length, where the throat may have a relatively small diameter and the downstream third section may have a relatively long length to allow more surface area for the slag to cover.

The second section 122 of the casing 101 may be configured to extend from the first section 121 generally in a horizontal direction, at an inclination angle relative to horizontal, or in a vertical direction. For example, the reactor may be vertically configured, such that the first section is provided above (or below) the second and/or third sections. The vertically aligned reactor having the combustion zone or section disposed above the downstream sections may be configured to utilize gravity to induce the slag layer (including the usable product) to flow or run down the reactor, such as to allow recovery of the usable product through a tap disposed at the bottom of the reactor.

As shown in FIG. 2, the casing 201 of the reactor 200 includes a first section 221 and a second section 222, which may have generally the same exterior size relative to one another. Alternatively, the first and second sections 221, 222 may have different exterior sizes. The first section 221 of the casing 201 may be provided at a first end 216 of the reactor 200, and the second section 222 of the casing 201 may extend from the first section 221 to a second end 217 of the reactor 200. As shown, the second section 222 of the casing 201 is elongated relative to the first section 221.

The casings of the reactors, as disclosed herein, may be configured to include one or more than one layer. For example, the casing may include an outer structural layer (e.g., an outer wall) made from a material, such as steel or another suitable high strength material, that is configured to provide the strength and durability to the casing. The casing may also include more than one outer structural layers Also, for example, the casing may include an inner layer (e.g., an inner wall) in the form of an inner refractory layer that is configured to withstand the high temperatures (e.g., 1500-2500° C.) that occur within the reactor, such as during the combustion process. For example, the casing may include an inner refractory layer that is made from a refractory material or metal, such as niobium (Nb), molybdenum (Mo), tantalum (Ta), tungsten (W), zirconium (Zr) or rhenium (Re), and/or alloys or combinations thereof that may advantageously exhibit relatively high temperature resistance. The inner refractory layer may also be made from other insulating materials, such as silicon or silicon based compound, or from ceramics (e.g., zirconium dioxide, aluminum oxide, magnesium oxide, yttrium oxide, silicon carbide, silicon nitride, boron nitride, mullite, aluminum titanate, tungsten carbide, chromium oxide). The inner refractory layer may be configured as a cladding or lining covering the inner surface of the outer layer, may be formed as a separate tube and then provided within and adjacent to the outer layer, or may be configured in any suitable manner. It is noted that the outer and inner layers may be made from other suitable materials or methods, and those materials and methods disclosed herein are not intended as limiting.

Furthermore, the inner layer of the casing may be made from more than one refractory material. For example, the inner layer (e.g., wall) of the first section 121 of the casing 101 may include a first refractory material, and the inner layer of the second section 122 of the casing 101 may include a second refractory material. The second refractory material may have a higher or lower temperature resistance compared to the first refractory material, such as to tailor the heat resistance of certain regions of the casing to the temperatures that the regions are expected to be subjected to during operation (e.g., combustion) of the reactor. Also, for example, the inner wall of the third section 123 may include a third refractory material that is different than the first and/or second refractory materials to further tailor the heat resistance of the reactor 100. Thus, the different regions of the casing may include different refractory materials, which may be tailored to withstand different temperature levels. They may also may be configured to withstand different level of corrosive environments. For example, a different refractory material may be employed in regions where no ash-bearing material is present (e.g., in the first section 121 or first section 102a of the chamber 102), compared to regions where ash-bearing materials are present, such as in the third section 123 of the casing 101 or third section 102c of the chamber 102 where slag (e.g., a molten slag layer) is formed along the inside of the inner layer of the reactor.

As shown in FIG. 1, the casing 101 includes three layers, with a first layer in the form of an outer structural layer (e.g., the outer wall 114), a second layer in the form of an inner refractory layer (e.g., the inner wall 115), and a third layer in the form of an intermediate layer 116 (e.g., an intermediate wall) is provided between the inner and outer layers. The intermediate layer 116 may be made from a structural material, a refractory material, or a combination thereof. According to one example, the inner wall 115 is made out of a relative high density refractory layer (e.g., ceramics, zirconium oxide, etc.) that is configured to withstand temperatures of in excess of 2000° C., the intermediate layer 116 is made out of a lower density and high porosity refractory layer that is configured to withstand temperatures of at least 1800° C., and the outer wall 114 is made out of a material that has better insulating properties, but can withstand lower relative temperatures (e.g., about 1400° C.). Examples of materials for the outer wall 114 may include, but are not limited to, alumina, aluminosilicates, cast ceramics, sintered brick, as well as other suitable materials. The thicknesses of each layer may be configured differently. For example, the inner layer may be configured to have a thickness that is equal to or less than about one-third the thickness of the intermediate layer.

As shown in FIG. 2, the casing 201 has two layers including an outer structural layer 214 (e.g., outer wall) and an inner refractory layer 215 (e.g., inner wall). The outer structural layer 214 may be configured having a generally uniform thickness through the second section 222 of the casing 201. The inner refractory layer 215 may be configured having a varying cross-section, such as along the longitudinal axis LA of the reactor 200. As shown, the inner refractory layer 215 includes first and second portions 215a, 215b that are configured to divide the chamber 202 into second and third sections 202b, 202c, respectively. The second portion 215b of the inner layer 215 is configured having a generally uniform thickness (e.g., cross-sectional thickness). The first portion 215a of the inner layer 215 is configured having a cross-section that changes in size moving along the longitudinal axis. For example, the first portion 215a may have an increasing size (e.g., thickness) moving from the first section 202a to the third section 202c of the chamber 202 to narrow the size (e.g., cross-section) of the second section 202b of the chamber 202. Thus, the inner layer 215 may include a feature (e.g., a throat, a venturi) formed therein, as discussed below in more detail.

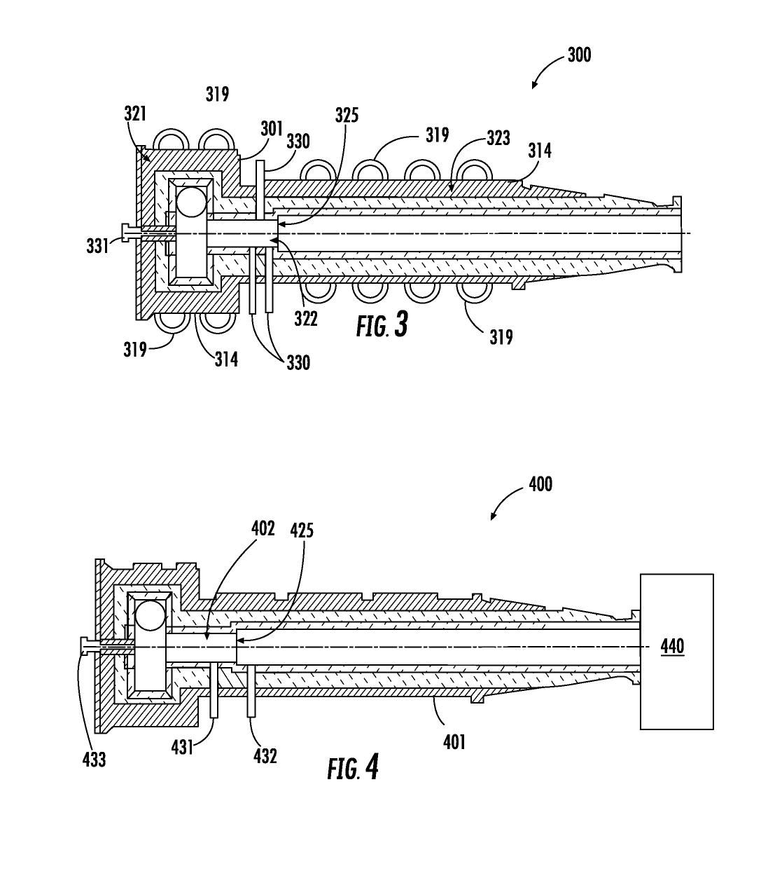

The reactors, as disclosed herein, may further include a device to help regulate (e.g., control, influence, etc.) the temperature of the casing. For example, the reactor may include one or more tubes that are configured to circumscribe at least a portion of the casing to regulate (e.g., control, influence, etc.) the temperature of the casing. As shown in FIG. 3, a first tube 319 circumscribes the outer wall 314 of the first section 321 of the casing 301 of the reactor 300, and a second tube 319 circumscribes the outer wall 314 of the third section 323 of the casing 301. The tubes 319 may be configured to carry a fluid (e.g., water, oil, air, etc.), which may be used to regulate the temperature of the outer wall 314 during operation of the reactor 300, such as to cool the outer wall 314. The fluid may be configured to be housed in the tubes 319, such that heat is transferred to the fluid through both the casing 301 (e.g., the outer wall 314) and the tube 319. Alternatively, the fluid may directly contact the casing 301, such as where the tube 319 has a semi-annular shape that is directly connected to the outer surface of the casing to form a channel between the tube 319 and the casing 301 for the fluid to flow through. According to an exemplary embodiment, a plurality of tubes may be annular in shape to wrap around the circular shape of the housing. In this configuration, the plurality of tubes may have a side-by-side arrangement around the housing. According to another exemplary embodiment, a tube may have a helical and may be configured to wrap and wind around the outer wall of the housing.

The fluid may be directed (e.g., forced) into the tube(s) from a temperature regulating device, such as a heat exchanger. Further, the fluid may exit the tube(s) and pass back into the temperature regulating device to form a thermodynamic cycle. Thus, for example, the fluid may absorb heat from the outer wall of the housing as the fluid passes over the wall, conducting some heat away from the wall and into the fluid. The heat remaining in the first fluid may then be absorbed by a downstream temperature regulating device, which may consist of another heat exchange arrangement (e.g., a second heat exchanger) where a second fluid is heated by cooling of the first fluid.

As shown in FIG. 1, the burner 103 is provided at the first end 117 of the reactor 100 and is configured to combust one or more reactants within the chamber 102 of the casing 101, such as the first section 102a of the chamber 102. The burner 103 may be an axial fired burner that is configured to combust the reactant(s) in a flame zone that extends generally along the longitudinal axis LA. Alternatively, the burner 103 may be a tangentially fired burner, which may be configured to induce swirl in a tangentially fired combustion zone. For example, the first section 102a of the chamber may be the combustion zone, such as the tangentially fired combustion zone induced by the tangentially fired burner 103. The combustion of the reactants in the first section 102a of the chamber 102 may produce heat in an exothermic reaction, where the heat produced is supplied downstream in the reactor 100 for the endothermic carbothermic reactions. For example, the carbothermic reactions may take place in the sections of the chamber (e.g., the second section 102b of the chamber, the third section 102c of the chamber) that are downstream of the combustion zone.

The burner 103, regardless of orientation within the reactor, is configured to provide a flame that is configured to combust the reactant(s) in a flame zone. The burner 103 may be provided at locations other than the first end 117 of the casing 101 and initiate combustion of the reactant(s) in the first section 102a or another section of the chamber. The flame zone produced by the burner 103 may be configured to extend beyond the first section 102a into the second section 102b of the chamber 102 to continue combustion therein. The burner 103 may be aligned near a central axis of the chamber relative to the inner wall 115 to allow the flame to extend toward or into the second section of the chamber, such as generally along the longitudinal axis LA. As shown in FIG. 1, the burner 103 is provided substantially collinear with the longitudinal axis LA. The burner 103 may have any suitable configuration that is able to ignite the reactant(s) introduced into the reactor. For example, the burner 103 may include any now known or future developed device for producing the flame to combust the reactants in the chamber of the reactor.

The first inlet 111 is configured to introduce a first reactant, such as air or fuel, into the reactor, such as the first section 102a of the chamber 102 of the reactor 100. According to an exemplary embodiment, the first inlet 111 is configured to introduce a non-ash bearing fuel source, such as natural gas, into the reactor 100. Using a non-ash bearing fuel as a reactant may advantageously prevent the buildup of solid materials, such as carbonaceous material (e.g., soot, ash, etc.), slag, or minerals. For example, introducing non-ash bearing fuel reactants may prevent the buildup of materials in the combustion section or near the throat. According to another exemplary embodiment, the first inlet 111 is configured to introduce biomass as the fuel, which may be a non-ash bearing biomass. The non-ash bearing biomass may be a liquid (e.g., condensed pyrolysis oils or pyrolysis tars) and/or a gas (e.g., flammable pyrolysis gases containing carbon monoxide, hydrogen, methane, etc.). According to yet another exemplary embodiment, the first inlet 111 may introduce a hybrid fuel, such as, for example, a combination of natural gas and biomass. The first inlet 111 may be configured to introduce an ash bearing fuel source into the reactor 100. Other fuel sources, including ash-bearing fuels, may be introduced into the reactor through the first inlet 111.

The first inlet 111 may be configured to introduce multiple co-reactants into the reactor. The first inlet 111 may be formed of any suitable material that is strong and durable enough to allow for the repeated conveyance (or transfer) of material (e.g., reactants) through the inlet and into the reactor 100. The first inlet 111 may be configured as a tube, pipe, or have any suitable configuration that is able to transfer reactant(s) into the reactor 100. The first inlet 111 includes an entrance that is connected to a device (e.g., an input assembly) that feeds the first reactant(s) into the first inlet 111. The first inlet 111 includes an exit that is connected to the casing 101, such as the first section 121, to direct the reactant(s) into the first section 102a of the chamber 102.

As shown in FIGS. 1 and 1A, the first inlet 111 is configured as a pipe (e.g., a circular shaped pipe) that is integrally formed with the casing and that is provided generally at the first end 117 of the casing 101 at a first tangential location relative to the first section 102a of the chamber 102. The first inlet 111 may extend away from a first side of the casing 101 (e.g., the left side as shown in FIG. 1A) in a generally horizontal direction. The first inlet 111 may have a central axis (e.g., a first central axis FCA), which may be provided offset above the longitudinal axis LA of the casing 101 as shown in FIG. 1A. The first central axis FCA of the first inlet 111 may extend in a direction that is generally transverse to the longitudinal axis LA.

The second inlet 112 is configured to introduce a second reactant, such as air or fuel, into the reactor, such as the first section 102a of the chamber 102 of the reactor 100. The second inlet 112 may be configured to introduce multiple co-reactants into the reactor. The second inlet 112 may be formed of any suitable material that is strong and durable enough to allow for the repeated conveyance (or transfer) of material (e.g., reactants) through the inlet and into the reactor. The second inlet 112 may be configured as a tube, pipe, or have any suitable configuration that is able to transfer reactant(s) into the reactor 100. The second inlet 112 includes an entrance that is connected to a device (e.g., an input assembly) that feeds the second reactant(s) into the second inlet. The second inlet 112 includes an exit that is connected to the casing, such as the first section 121, to direct the reactant(s) into the first section 102a of the chamber 102.

As shown in FIGS. 1 and 1A, the second inlet 112 is configured as a pipe (e.g., a circular shaped pipe) that is integrally formed with the casing 101 and that is provided generally at the first end 117 of the casing 101 at a second tangential location relative to the first section 102a of the chamber 102 and/or the first inlet 111. The second inlet 112 may extend away from a second side of the casing 101 (e.g., the right side as shown in FIG. 1A) in a generally horizontal direction. The second inlet 112 may have a central axis (e.g., a second central axis SCA), which may be provided offset below the longitudinal axis LA of the casing 101 as shown in FIG. 1A. The second central axis SCA of the second inlet 112 may extend in a direction that is generally transverse to the longitudinal axis LA.

Therefore, the first and second inlets 111, 112 may be configured as tangential inlets in order to introduce the reactants at tangential locations along the first section 121 of the casing 101. This arrangement may advantageously produce swirl and turbulence in the chamber 102 of the reactor 100, which may help promote the high temperatures that are necessary for carbothermic reduction. The initial turbulence may be further increased in the chamber 102, such as by the throat to further increase the temperatures in the flame zone of the reactor, as discussed in more detail below. Alternatively, the first inlet 111 and/or the second inlet 112 may have first and/or second radial configurations relative to, for example, the longitudinal axis LA.

Also shown in FIG. 1, the reactor 100 may include an optional longitudinal inlet 119, which may be positioned generally at the longitudinal axis LA of the reactor. Thus, the optional longitudinal inlet 119 may be configured to introduce one or more than one reactant in a direction that is transverse to the first and second tangential inlets 111, 112 and/or parallel to the longitudinal axis LA. The longitudinal inlet 119 may help direct, for example, a secondary input reactant (e.g., a co-reactant) toward the throat or along the longitudinal axis, which may produce heat in the combustion zone and/or the throat of the second section 122.

As shown in FIGS. 2 and 2A, the first inlet 211 is configured as a rectangular shaped pipe that connects to the casing 201 at a first location, and the second inlet 212 is configured as a rectangular shaped pipe that connects to the casing 201 at a second location. The first inlet 211 may connect to an upper surface of the casing 201, and the second inlet 212 may connect to a lower surface of the casing 201. The first and second inlets 211, 212 may connect generally in line with the longitudinal axis LA, or may be offset from the longitudinal axis LA, such as in opposite directions from therefrom as shown in FIG. 2A. According to an exemplary embodiment, the first inlet 211 is configured to introduce co-reactants, including a fuel source and a metal oxide, into the chamber 202; and the second inlet 212 is configured to introduce an oxidant (e.g., air, oxygen) into the chamber 202 to combust with the fuel source.

The inlets of the reactors, as disclosed herein, (e.g., the first inlets 111, 211 and/or the second inlets 112, 212) may include a damper or other suitable device configured to regulate or adjustably control the flow rate of the reactants through the inlet(s). Accordingly, the reactor may be configured such that the first inlet introduces the first reactant (e.g., air) into the chamber at a first controlled (and adjustable) flow rate, and the second inlet introduces the second reactant (e.g., fuel) in the chamber at a second controlled (and adjustable) flow rate in order to fuel the reaction within the reactor in a controlled manner. Thus, the inlets may be configured having adjustable pressures to produce adjustable velocities that push the reactants through the inlet and into the combustion chamber.

It is noted that the reactors, as disclosed herein, may include a fewer or greater number of inlets from the reactors 100, 200. For example, the reactor may include a single inlet configured to introduce the reactant(s) into the chamber. Any additional inlets may be configured similar to, the same as, or different than the inlets described herein. For example, the reactors may include secondary inlets positioned downstream of the first section of the chamber, as described below.

The outlets 113, 213 of the reactors 100, 200 may be configured to provide for the removal (e.g., recovery) of a usable product (e.g., CaC₂) produced by the reactor, such as during and after combustion of the reactants, from the casing 101, 201. For example, each outlet 113, 213 may include a tap, a valve, or other suitable device that is configured to allow selective removal of the molten slag including the usable product from the reactor. As shown in FIGS. 1 and 2, the outlets 113, 213 are provided at the second end 118, 218 of the respective reactor. The outlet 113, 213 may also be configured to remove off gases (e.g., CO) formed by the reactions from the chamber. Alternatively, the reactors 100, 200 may include first and second outlets, where the first outlet is configured to provide for the removal of any usable products, and the second outlet is configured to vent (e.g., remove) any off gases from the reactor.

The reactors, as disclosed herein, may include a feature (e.g., throat, venturi) to induce a vacuum in the chamber to influence the turbulence and the temperature in the chamber to promote carbothermic reduction of the reactant(s) introduced into the chamber. The throat may be integrally formed with the casing, such as one or more layers of the casing, or may be formed separately then coupled to the casing.

As shown in FIG. 1, the throat 125 is provided by the second section 122 of the casing 102. The second section 122 is shown having a substantially uniform cross-sectional size between the first end 122a and the second end 122b. The throat 125 is configured having a smaller size (e.g., diameter) compared to the size of the section of the casing 101 that is located adjacent and upstream from the second section 122 (e.g., the first section 121). The size of the throat 125 may also be smaller than a size of the section of the casing 101 that is located adjacent and downstream from the second section 122 (e.g., the third section 123). The relative size differences between the throat and the upstream and/or downstream sections of the reactor may advantageously influence the velocity of the reactant(s) through the reactor and the temperature in the reactor to promote the carbothermic reduction of the reactant(s).

The throat 125 may be formed in the intermediate layer 116 and/or the inner layer 115 of refractory material underlying the intermediate layer 116. As shown, the second portion 102b of the chamber 102 has a uniform size (e.g., cross-sectional area, diameter) and, therefore, the size of the throat 125 is the same as the second portion 102b. Thus, the size of the second section 102b of the chamber 102 and the throat 125 may be smaller than the size of the chamber sections that are located upstream and/or downstream of the throat 125.

Alternatively, the section of the reactor defining the throat (e.g., the throat region) may be configured to have a non-uniform size and/or shape, such as having a varying size moving along the respective section of the casing. For example, the throat region may have a tapered shape (e.g., linear taper, curved taper, etc.). As shown in FIG. 2, the inner layer 215 of the casing 201 has a size (e.g., a thickness) that increases through a first portion 215a of the inner layer 215, which in turn defines a narrowing region 224 of the chamber 202 (e.g., the second section 202b of the chamber 202) that tapers to a throat 225 provided at an end (e.g., exit end) of the first portion 215a and the narrowing region 224. In other words, the narrowing region 224 may include a cross-section that varies, such as, for example, decreasing in size along the longitudinal axis LA of the reactor 200 moving from the first section 202a of the chamber 202 toward the third section 202c of the chamber 202. As shown, the thickness of the first portion 215a of the inner layer 215 is configured to progressively increase toward the throat 225 by having an outer surface with a uniform size and an inner surface that progressively moves farther away (e.g., inward) from the outer surface. Thus, the narrowing region 224 of the chamber 202 is configured having a frusto-conical shape that progressively narrows to the throat 225, at which it is the narrowest. However, the narrowing region 224 may be configured having other suitable shapes that induce the vacuum to increase the turbulence and the temperature in the chamber 202. For example, the inner surface of the first portion 215a of the inner layer 215 may be curved, such as concave or convex relative to the longitudinal axis LA. The inner layer 215 may be made of a refractory material, such that by having an increasing thickness from the first section 221 to the throat 225, the portions of the reactor that are subjected to the highest temperatures are able to withstand the highest temperatures.

The narrowing region 224 may be configured adjacent to and extending from the first section 202a of the chamber 202, or there may be one or more additional sections of the chamber provided between the first section 202a and the narrowing region 224. For example, there may be an intermediate section 202d disposed between the first section 202a of the chamber and the narrowing region 224 (e.g., the second section 202b of the chamber 202), which has a size (e.g., cross-section) that is greater than the size of the narrowing region 224, but less than the size of the first section 202a.

The narrowing region 224 may be configured having an angle (e.g., an angle of convergence), which may be measured relative to the longitudinal axis LA of the reactor. As shown in FIG. 2, the angle A, which is twice the angle of convergence, may be configured between 0° and 90°. According to an exemplary embodiment, the angle A is less than 15°, which may advantageously provide the most vacuum. As shown in FIG. 2, the throat has a taper having an angle A that is about 3-5° (i.e., 3-5°+/−1°). It is noted that these values are not limiting, as the narrowing region 224 may be configured differently.

The inner layer of the casing may include a second portion that extends from the first portion toward the outlet of the reactor. Also shown in FIG. 2, the portion (e.g., second portion 215b) of the inner layer 215 that is downstream of the throat 225 may have a larger size (e.g., cross-section) compared to the size of the throat 225. The second portion 215b of the inner layer 215 may have a substantially uniform size. As shown in FIG. 2, the second portion 215b of the inner layer 215 may be configured having a generally uniform thickness beyond the throat, such that the third section 202c of the chamber 202 is configured having a generally uniform size. For example, the second portion 215b may be cylindrical in shape and have an inner diameter that is larger than the diameter of the throat 225.

Alternatively, the section downstream of the throat may be configured having a non-uniform shape and/or size. As shown in FIG. 5, the reactor 500 includes a housing 501 having an outer layer 514, which may be structural, and an inner layer 515, which may be made from refractory material(s). Together the inner and outer layers 515, 514 define a chamber having a plurality of sections. The layers 514, 515 may define a first section 502a, a second section 502b, and a third section 502c of the chamber. The first section 502a may receive one or more reactants, which are then combusted. The second section 502b is configured as a narrowing region having a frusto-conical taper from an inlet end to an exit end of the section to influence the velocity and temperature of the reactant(s). A throat 525 is disposed at the exit end of the second section 502b. The third section 502c extends from the throat 525 toward an outlet 513 of the reactor 500. As shown, the third section 502c is configured as a widening region having a uniformly increasing size (e.g., cross-section) moving from an inlet end to an exit end of the third section 502c. The inlet end of the third section 502c may be the same size (e.g., diameter) as the throat 525, and the exit end of the third section 502c may have a larger size than the throat. Thus, the third section 502c may be configured as a frusto-conical shape having an angle of divergence, which may be measured relative to the longitudinal axis LA and/or to itself.

The widening region may be configured having an angle (e.g., an angle of divergence) of between 0° and 90°, and preferably is less than 90°. More preferably, the angle is configured to be less than the angle A. According to other examples, the third section 502c may have a non-uniform (e.g., non-linear, curved, etc.) widening arrangement moving from the throat 525 toward the outlet 513. The reactor 500 including the increasing tapered section (e.g., the third section 502c) downstream of the throat 525 may advantageously have a lower pressure drop compared to the reactor including a downstream section having a uniform size, such as the reactors of FIGS. 1-4. In other words, the reactor having a gradually expanding chamber section following the throat will have a relative lower pressure drop compared to a reactor having a uniform sized chamber section following the throat, which is larger than the throat.

The reactor 500 may optionally include additional chamber sections downstream of the third section 502c. Also shown in FIG. 5, a fourth section 502d of the chamber having a substantially uniform size may extend from the exit end of the third section 502c to the outlet 513 of the reactor 500. For example, the fourth section 502d may be cylindrical shaped having the same size as the exit end of the third section 502c.

According to an exemplary embodiment, the throat is configured as a venturi in order to induce a vacuum, which may draw in (e.g., suck) the reactants and/or other materials, which may be introduced into the reactor, to expose the reactants/materials to the high temperatures in the vacuum. The throat may increase the flow of the reactants (e.g., the velocity of the reactants) through the chamber and may advantageously increase the temperature in the chamber to help provide the relatively high flame temperatures (e.g., 1500-2500° C.), which are necessary for the carbothermic reduction of, for example, calcium oxide (CaO) to CaC₂. The tangential injection of reactants into the throat may also promote swirl in the chamber, which may increase the turbulence through the throat upstream of the throat, and/or downstream of the throat. The increased turbulence may advantageously increase the shear forces in the fluid flow, which may tear away any solid materials, such as carbonaceous material (e.g., soot, ash, etc.), slag, minerals, and/or slag, from the inner surface of the reactor. This arrangement may advantageously help keep the inner surface relatively free of buildup of solid materials. The increased turbulence may also advantageously promote mixing and high rates of carbothermic reduction while reactant materials are in-flight before downstream deposition to the walls of the chamber where additional carbothermic reduction is expected to occur.

The throats and/or the narrowing regions (e.g., venturi) may be configured having relatively smooth transitions (e.g., a continuous uninterrupted taper), which may help streamline the velocity through the chamber and avoid circular eddies in the chamber. This arrangement may advantageously help increase the suction of the vacuum, which may, for example, help prevent the surface of the throat and/or narrowing region to remain clean (e.g., free of build-up of solid materials or debris).

The reactors, as disclosed herein, are configured to receive reactants (e.g., air, fuel, etc.) into the first section of the chamber through the inlet(s) of the reactor. A burner produces a flame zone configured to combust the reactants passing through the chamber, such as toward the throat. As the reactants flow through the chamber toward the throat, the throat induces a vacuum to increase the turbulence and increase the combustion temperature of the reactants in the chamber. The vacuum may be initiated upstream of the throat, such as in the narrowing region as shown in the example of FIG. 2, and may increase until reaching a maximum at the throat, such as at the narrowest region (e.g., at the smallest cross-section) of the throat or region. The vacuum may also be strongest near the longitudinal axis of the chamber. The vacuum may draw in more of the reactants and/or other materials (e.g., CaO), such as along the periphery of the flow, to expose them to the higher temperatures. For example, by exposing the CaO to the higher temperatures in the flame zone, the process of producing CaC₂ may be sped up, such as by producing at least some CaC₂ in the flow and prior to residence along the wall of the reactor. A slurry of material, such as coke or coal mixed with CaO, may be introduced, such as through a secondary inlet, as discussed below, thereby exposing the slurry and reactants to the relatively high temperatures, which may melt the materials in flight, such that they hit the wall in a molten state to deposit on the wall to have carbothermic reactions. In other words, the carbothermic reactions continue beyond the throat (e.g., in the third section of the chamber) as the flow moves along the longitudinal axis of the reactor toward the outlet to promote the production of additional usable products, such as CaC₂. For example, the reactants (e.g., solids and melt) may be thrown to the inner surface of the wall by centrifugal forces and/or turbulent forces, where the reactants may continue the carbothermic reduction of CaC₂ along the wall. Additionally, the flow of high temperature (e.g., greater than 1500° C.) off gases along the longitudinal axis may continue to promote the carbothermic reduction along the wall. Thus, a carbide laden slag, which may be molten, may form along the wall of the reactor, and may be removed from the reactor after a predetermined degree of completion.

The formation of the slag layer in the chamber downstream from the throat may be influenced or tailored, such as through the introduction of materials (e.g., additives) that effect the characteristics (e.g., melt, flow, etc.) of the slag layer. For example, melt promoting additives may be introduced into the throat of the reactor to promote the formation of the slag layer during operation of the reactor so that the carbothermic reaction can be carried out at lower temperatures in a melt. As another example, the additives may serve as fluxants configured to lower the melting of ash and lower the temperature at which dissolution of the CaO occurs in the melt. The fluxant additives may be configured to promote the flow of the melt, such as by influencing (e.g., decreasing) the viscosity of the slag layer, to allow the carbon to move more freely in the liquid layer, which may speed up the reaction between the carbon and the CaO to promote the production of the CaC₂. As another example, catalytic additives may be introduced into the throat of the reactor to accelerate the formation of the product (e.g., CaC₂) in the melt as part of the slag layer. The presence of CaC₂ in the slag layer, may serve to promote the chemical reaction that forms additional compounds of CaC₂. In this case, the input reactant being fed into the reactor may be partially converted reactants from another reactor system or alternatively the injected reactants may be doped with relatively pure CaC₂ in order to serve as a catalyst in the formation of CaC₂ in the slag layer.

The reactors, as disclosed herein, may include one or more than one secondary inlet, which may be provided upstream and/or downstream of the throat, and/or a temperature regulating device. For example, the reactor may include a single secondary inlet provided upstream of the throat and downstream of the first section of the casing and/or the chamber.

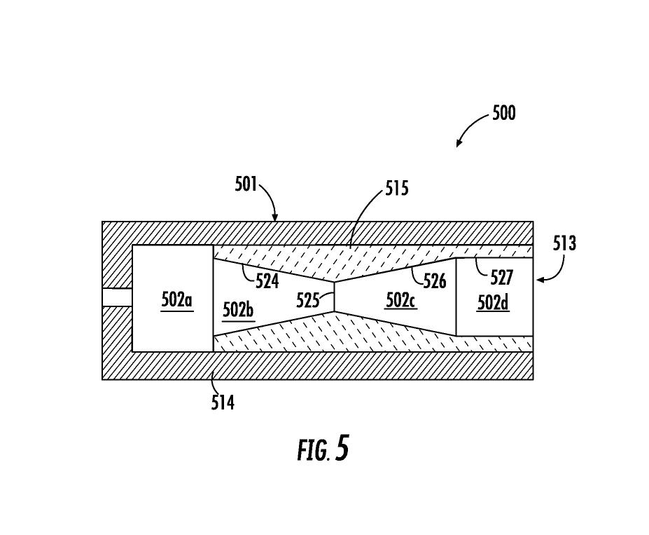

FIGS. 3 and 4 illustrate other exemplary embodiments of reactors 300, 400 that include secondary inlets. As shown in FIG. 3, the reactor 300 includes a plurality secondary inlets 330 configured to introduce co-reactants into a second section 322, which is located downstream of the first section 321 and upstream from the throat 325. The plurality of secondary inlets 330 include third and fourth inlets disposed on a lower side (e.g., a bottom) of the casing 301 and a fifth inlet disposed on an upper side (e.g., a top) of the casing 301. Each secondary inlet 330 may extend in a direction that is transverse (e.g., perpendicular) to the longitudinal axis. Each secondary inlet 330 may extend through the casing 301 into the section of the chamber defining the throat 325 to allow for at least one co-reactant, element, or compound to be introduced into the chamber. The remaining configuration of the reactor 300 (e.g., other than the secondary inlets 330 and the tubes 319 discussed above) may be generally the same as or similar to any other reactor disclosed herein (e.g., the reactor 100 of FIG. 1).

As shown in FIG. 4, the reactor 400 includes a pair of secondary inlets 431, 432. A first secondary inlet 431 is provided upstream of the throat 425, and a second secondary inlet 432 is provided downstream of the throat 425. The first secondary inlet 431 introduces a co-reactant, element, compound, or any suitable combination thereof into the chamber 402 between the first section and the throat 425, and the second secondary inlet 432 introduces a co-reactant, element, compound, or any suitable combination thereof into the chamber 402 between the throat 425 and the outlet. Thus, the secondary inlets 431, 432 may introduce a material (e.g., co-reactant) into the section of the chamber in which the carbothermic reduction reaction occurs.

Also shown in FIGS. 3 and 4, the reactors 300, 400 may be configured including an optional longitudinal secondary inlet 331, 433 (e.g., a centerline injection) that is configured to introduce one or more than one reactant into the reactor. For example, the optional longitudinal secondary inlet 331, 433 may introduce a secondary reactant directly into the flame zone and/or combustion zone, such that the reactant is flowing generally in a direction along the longitudinal axis. The optional longitudinal secondary inlet 331, 433 may be adjustable or adjustably configured. For example, the optional longitudinal secondary inlet 331, 433 may be retractable and/or extendible along the longitudinal direction, such as to adjust the position where the one or more than one reactant is being introduced into the reactor. The adjustable secondary inlet may advantageously allow for the at least one reactant to be injected directly into the flame, upstream of the flame by a predetermined distance, or downstream of the flame by a predetermined distance.

Each secondary inlet may be configured to introduce a secondary material (e.g., a second input reactant) into the reactor. For example, each secondary inlet may be configured to introduce a residual oil (e.g., coal tar, aromatic oils from petroleum, biochar created from pyrolysis processes, etc.) into the chamber of the rector. The residual oil may preferably be a low cost, viscous material. For example, the residual oil may be a slurry of oil, finely ground coal particles, and finely ground calcium oxide particles. A calcium source (e.g., calcium oxide, calcium hydroxide, calcium carbonate, etc.) is essential for calcium carbide production. The residual oil may be preheated to promote higher temperatures in the chamber and is introduced to promote formation of the usable product in the chamber by reacting in flight and/or promoting the production of a usably product. For example, the residual oil may be introduced at an downstream location relative to the throat (as shown in FIG. 4). By introducing the residual oil into the flame zone with the reactants, the relatively high temperatures may crack the materials into their elements (e.g., constituent elements), such as carbon and hydrogen. In other words, the residual oil may decompose thermally in the chamber to promote the carbothermic reactions to produce the usable products.

According to an exemplary embodiment, the at least one secondary inlet is configured to introduce a product source, such as a calcium source, and a carbon source as the secondary input reactants. The calcium source may comprise calcium oxide (CaO), calcium carbonate (CaCO₃), lime, a combination thereof, or any other suitable material including calcium. The carbon source may comprise coal, coke, a combination thereof, or any other suitable material including carbon. Additionally, the one or more than one secondary input reactant may be configured as a co-reactant. For example, the co-reactant may comprise an oxide, hydroxide, carbonate (e.g., of calcium, lithium, sodium, potassium, magnesium, etc.), or any other suitable element or compound. By introducing the calcium source and the carbon source, the carbothermic reactions in the reactor may produce a usable product, such as CaC₂.

It should also be noted that the reactor may be configured to produce other useful products instead of or in addition to calcium carbide (CaC₂), including, but not necessarily limited to other carbides formed from the elements of groups one and two in the periodic table, such as lithium carbide (Li₂C₂), sodium carbide (Na₂C₂), potassium carbide (K₂C₂), and magnesium carbide (Mg₂C₃ or MgC₂). For example, the reactor may be configured to produce sodium carbide (Na₂C₂) and carbon monoxide from sodium oxide (or sodium carbonate) and carbon. Sodium carbide can be reacted with water to produce acetylene and sodium hydroxide. It is also believed that other acetylides may be formed within the reactor from the transition metal elements (e.g., group 11 of the periodic table), from the metal elements (e.g., group 12 of the periodic table), from lanthanoids (e.g., lanthanum (La), cerium (Ce), praseodymium (Pr), terbium (Tb)), steel, metallic silicon, aluminum, or other carbides. For example, copper carbide (Cu₂C₂) or zinc carbide (ZnC₂) may be able to be formed from within the reactor. Also, the reactor may be fed with bio-derived carbonaceous materials, such as biomass, biocoal, biochar, or a combination thereof, to produce bio-derived chemicals, such as bio-derived carbides. According to other exemplary embodiments, the systems and techniques discussed herein may be used to facilitate other reduction reactions, such as the reduction of iron oxides to elemental iron.

Slag viscosity modifier additives may include low melting feldspar minerals. Feldspars typically melt at temperatures of around 1000° C.˜1200° C. and are the most abundant group of minerals in the earth's crust. Feldspars are alkali containing mineral deposits comprised of individual, or mixed, alkali metal components; typically sodium, potassium, and calcium. Sodium feldspar (albite) has the chemical formula: Na₂O.Al₂O₃.6SiO₂. Potassium feldspar (orthoclase) has the chemical formula: K₂O.Al₂O₃.6SiO₂. Lime feldspar (anorthite) has the chemical formula: CaO.Al₂O₃.2SiO₂. In addition to serving as fluxing agents to reduce the melting temperature and viscosity of slag melts, these feldspars may also serve as feedstock for the reactor, carbothermically reduced at elevated temperatures in the presence of carbon char, resulting in the formation of desired acetylides: sodium carbide (Na₂C₂), potassium carbide (K₂C₂) and calcium carbide (CaC₂); all of which readily hydrolyze when contacted with water to form acetylene.

As shown in FIG. 4, the reactor 400 includes a temperature regulating device 440 provided near the outlet end of the reactor. Other than the temperature regulating device 440 and the secondary inlets 431, 432, the remaining configuration of the reactor may be generally the same as any other reactor disclosed herein (e.g., the reactor 100 of FIG. 1). Alternatively, the reactor 400 may be configured differently than the other reactors disclosed herein.

The temperature regulating device 440 is configured to reduce the temperatures inside the chamber of the reactor 400. For example, the temperature regulating device 440 may be configured to cool the hot off-gases produced by the reactor. The temperature regulating device may include a water scrubber, a fluid (e.g., water) spray, or another suitable device that can quickly cool the material in the reactor from the high temperatures down to a lower temperature, such as 130° C. Alternatively, the hot off-gases produced by the reactor may be used in a boiler, such as for fuel in the boiler provided downstream of the reactor.

It is noted that although FIG. 4 shows a temperature regulating device provided at the outlet, a more preferable configuration is to provide a slag removal system, such as a tap, at the outlet and/or send off gases downstream, such as to a furnace. In other words, the high temperature off gases may preferably not be cooled, and may be blown into a furnace or used to provide heat. For example, in place of the temperature regulating device, the reactor may include a separating device or separating zone, where the hot off gases disengage from the material (e.g., the slag, the usable product). In other words, the hot off gases may separate from the material in the separation zone, and the device may be configured to direct the hot off gases in a first direction and the slag including the usable product in a second direction, which is different than the first direction.

Now, a calculation of one example for a venturi reactor is provided for the production of CaC₂ using coal and CaO. For this calculation, a reactor similar to the embodiment of FIG. 3 was used, where methane (CH₄) as a fuel and oxygen (O₂) enter the reactor through two separate inlets in the first section of the reactor, while coal and CaO enter the reactor through a common inlet near the exit of the second section.

For this calculation, it was assumed that 1.75 kg/hr of methane is fed tangentially into the first chamber through a first inlet of the first section and 7.1 kg/hr of O₂ is fed through a second inlet in the first chamber where the methane and oxygen combust producing a hot off gas mixture of CO, CO₂, H₂, water vapor and unreacted O₂. A steam jacket around the first chamber is used to remove excess heat and maintain a temperature of 2300° C. The hot off gas travels into the second section.

For this calculation, it was assumed that 32.7 kg/hr of coal and 84 kg/hr of CaO enter the venturi reactor through a common inlet in the second section, where they are mixed and heated with the hot off gas. As the coal is heated, it releases all its volatile matter, including hydrogen, sulfur, oxygen, nitrogen and some of its carbon. The oxygen from the coal, as well as the O₂ in the original off gas, and the hydrogen react with the remaining gaseous compounds to produce mainly CO, CO₂, H₂O, H₂S and SO₂. As the gas and solid travel into the third section of the reactor, the solid coal particles are softened at these elevated temperatures and impact the walls of the reactor, creating a molten slag layer that slowly flows down the reactor walls toward the exit of the third section. Similarly, the CaO particles, upon hitting the walls of the reactor, are trapped in the molten slag where they flow with the slag and react with the carbon in the slag layer. For this calculation, 75% of the carbon was calculate to react with the CaO, in the manner described above, producing CaC₂ solid and CO gas. The exiting slag flow rate is 29.8 kg/hr, with 25.0 kg/hr of CaC₂ (83.9% purity). Because of the endothermic reaction, the exiting slag layer and off gas are at 1800° C. By the time the off gas exits the third section of the reactor, all the O₂ has fully reacted and the final gas composition (at thermodynamic equilibrium) is:

| Compound | Molar % |
|---|---|
| O₂ | 0% |
| CO | 43.9% |
| CO₂ | 3.9% |
| H₂ | 36.6% |
| H₂O | 14.9% |
| N₂ | 0.6% |
| H₂S | 0.3% |
| SO₂ | 0.013% |

The off gas travels to a downstream reactor where air or O₂ is introduced to allow combustion to go to completion and heat is extracted from the gas stream, for example to produce high pressure steam for power generation.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the reactors as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed, such as the casings of the reactors, may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present invention. For example, any element (e.g., inlet, burner, casing, etc.) disclosed in one embodiment may be incorporated or utilized with any other embodiment disclosed herein.

What is claimed is:

1. A process for producing a usable product in a reactor, the process comprising:
introducing co-reactants comprising a fuel source and oxygen into a first section of the reactor through at least one inlet, wherein the fuel source comprises carbon;
combusting at least a portion of the fuel source and oxygen in an exothermic reaction in the first section, wherein a burner is provided to generate a flame to combust the fuel source and oxygen;
transferring the co-reactants through a second section of the reactor, the second section including a throat having a size that is smaller than a size of the first section, such that a vacuum is induced and a velocity of the co-reactants increases through the reactor;
transferring the co-reactants into a third section of the reactor that is downstream from the throat, the third section including an inner wall having a size that is greater than the size of the throat;
depositing at least a portion of the uncombusted carbon and a metal oxide along the inner wall of the third section, wherein the metal oxide is introduced into at least one of the first, second, and third sections of the reactor;
converting the deposited metal oxide into the usable product in a carbothermic reduction reaction within a molten slag along the inner wall, wherein the carbothermic reaction occurs at a temperature of at least 1600° C.; and
recovering the molten slag containing the usable product from the reactor.

2. The process of claim 1, wherein the size of the throat decreases moving from a first end of the throat that is adjacent to the first section to a second end of the throat that is adjacent to the third section of the reactor.

3. The process of claim 2, wherein the size of the throat decreases at a constant rate and continuous manner from the first end to the second end of the throat.

4. The process of claim 1, wherein the at least one inlet comprises first and second inlets, wherein each of the first and second inlets is tangentially aligned relative to the first section in a direction that is transverse and offset from a longitudinal axis of the reactor to swirl the co-reactants introduced into the first section.

5. The process of claim 4, wherein at least one of an additive, a carbide, a residual oil, and a calcium source is introduced into the third section of the reactor through a third inlet to promote the formation of the molten slag along the inner wall.

6. The process of claim 1, wherein a compound comprising at least one of an additive, a carbide, a residual oil, and a calcium source is introduced into the second section of the reactor through a secondary inlet.

7. The process of claim 1, wherein the molten slag is recovered from the reactor through a first outlet, and wherein the reactor also includes a second outlet through which off gases are removed from the reactor.

8. The process of claim 1, wherein the conversion of the metal oxide to the usable product occurs by reacting the deposited metal oxide with carbon, wherein the carbon is from at least one of the fuel source, combustion off gas, and another co-reactant introduced into the first section.

9. The process of claim 1, wherein the usable product comprises a carbide that comprises at least one element from at least one of groups one and two of the periodic table.

10. A process for producing a usable product in a reactor, the process comprising:
introducing co-reactants into a first chamber defined by a cylindrical first section having an inner diameter, wherein the co-reactants comprise at least a fuel source and oxygen, the fuel source comprising carbon;
combusting at least a portion of the fuel source and oxygen in the first chamber using a burner in an exothermic reaction;
transferring the co-reactants from the first chamber to a second chamber fluidly connected therewith, wherein the second chamber is defined by a second section that extends between first and second ends, wherein a size of the first end is smaller than the inner diameter of the first section;
transferring the co-reactants from the second chamber to a third chamber fluidly connected therewith, wherein the third chamber is defined by a cylindrical third section having an inner diameter that is larger than a size of the second end; and
forming a molten slag in the third chamber by carbothermic reduction of uncombusted carbon and a metal oxide, wherein the metal oxide is introduced into at least one of the first, second, and third chambers;
wherein the molten slag contains at least a portion of the usable product; and
wherein the difference between the size of the first end and the inner diameter of the first section and between the size of the second end and the inner diameter of the third section influences a velocity and a temperature to promote the carbothermic reduction of the uncombusted carbon and the metal oxide.

11. The process of claim 10, wherein the size of the first end is the same as the size of the second end, and wherein the second section has a constant size throughout.

12. The process of claim 11, wherein the second section is cylindrically shaped having a constant inner diameter that is smaller than the inner diameters of both of the first and third sections.

13. The process of claim 10, wherein the size of the first end is larger than the size of the second end, such that the size of the second section progressively narrows moving from the first end to the second end.

14. The process of claim 13, wherein the second section is frusto-conical shaped.

15. The process of claim 10, wherein the first end is connected to the first section through a first side wall, and wherein the second end is connected to the third section through a second side wall.

16. The process of claim 10, wherein the usable product comprises at least one element from at least one of group eleven of the periodic table, group twelve of the periodic table, and lanthanoids.

17. The process of claim 16, wherein the conversion of the at least one element to the usable product occurs by reacting the deposited elements with carbon, wherein the carbon is from at least one of the fuel source, combustion off gas, and another co-reactant introduced into the first section.

18. A process for producing a usable product in a venturi reactor, comprising:
introducing co-reactants into a first chamber, the co-reactants comprising carbon and oxygen;
combusting at least a portion of the co-reactants in the first chamber;
transferring the co-reactants from the first chamber to a second chamber, wherein the second chamber is configured as a continuously uninterrupted tapered body to increase a velocity of the co-reactants; and
transferring the co-reactants from the second chamber to a third chamber, wherein uncombusted carbon and a compound react in a molten slag to form usable product;
wherein the compound is introduced into at least one of the first and third chambers of the reactor; and
wherein the compound comprises at least one of an oxide, a hydroxide, and a carbonate.

19. The process of claim 18, wherein the compound and uncombusted carbon react within the molten slag in a carbothermic reduction reaction at a temperature of at least 1600° C., and wherein the molten slag forms along an inner wall of the reactor.

20. The process of claim 19, wherein the compound is introduced into the first chamber, and wherein a second compound comprising at least one of an additive, a carbide, a residual oil, and a calcium source is introduced into the third chamber of the reactor in order to further promote the carbothermic reaction in the third chamber.

21. The process of claim 18, wherein the carbon is a hybrid fuel source comprising carbon from a biomass and carbon from a non-biomass carbon source.

22. The process of claim 18, wherein the second chamber is configured as a linear tapered body that is continuous and uninterrupted along the entire body.
